(19) United States
(12) Patent Application Publication
(10) Pub. No.: US 2020/0145824 A1
(43) Pub. Date: May 7, 2020

(54) Localized Multi-Factor Network Authentication

(71) Applicant: Comcast Cable Communications, LLC, Philadelphia, PA (US)

(72) Inventors: Donald J. Jones, JR., Bennett, CO (US); Adam Eng, Golden, CO (US); David Eng, Philadelphia, PA (US)

(21) Appl. No.: 16/181,099

(22) Filed: Nov. 5, 2018

(51) Int. Cl. H04W 12/06; H04W 48/02; H04L 29/06

(52) U.S. Cl. CPC H04W 12/06; H04L 63/0876; H04W 48/02

(57) ABSTRACT

Systems, apparatuses, and methods are described for localized multi-factor network authentication are disclosed. A computing device associated with a network may provide an access code via a power line network of a premises and may request that devices attempting to gain access to a wireless network provide the access code. Access of devices to the wireless network may be blocked or limited based on monitored behavior.

### BACKGROUND

Internet enabled devices may communicate with each other over a network to connect and exchange data. Some such devices may be intended to provide beneficial interconnectivity, but may have minimal security requirements. Such devices, or other devices, may be compromised or otherwise used for malicious purposes.

### SUMMARY

The following summary presents a simplified summary of certain features. The summary is not an extensive overview and is not intended to identify key or critical elements.

Methods, systems, and apparatuses are described for performing multi-factor authentication via power line networks and connected devices, and/or monitoring such devices for abnormal behavior. Power lines may be associated with a premises and be used to form a power line network. Because of the nature of the electrical wiring (e.g., being optimized for carrying higher voltage electricity instead of data signals, having fuses and/or circuit breakers that may hinder data signal propagation, etc.), communications through a power line network may be localized to the premises and may be more difficult for an outsider to intercept and/or hack. A first computing device controlling access to a wireless network may be configured to communicate one or more access codes via a power line network. The first computing device may request that other computing devices attempting to access the wireless network provide the one or more access codes. Based on whether a requested access code is received, access to the wireless network may be enabled. Additionally or alternatively, the first computing device may receive identifiers of devices attempting to connect to the network and determine, based on the identifiers, expected normal behavior of those devices. The first computing device may identify abnormal behavior and determine whether to deny network access, block network access, throttle network access, etc.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example premises comprising a power line network and a wireless network.

FIG. 4A is a flow chart showing an example method of a user device attempting to authenticate to gain access to a wireless network.

FIG. 4B is a flow chart showing an example method of a computing device authenticating a device in response to a network access request.

FIG. 5 is a flow chart showing an example method for monitoring device communications with a network.

FIG. 6 shows an example table indicating devices, device identifiers, and network access status.

FIG. 7 shows an example table representative of devices and corresponding known normal behavior for those devices.

FIG. 8 shows an example graphical user interface for a user device attempting to connect to a network.

### DETAILED DESCRIPTION

The accompanying drawings, which form a part hereof, show examples of the disclosure.

It is to be understood that the examples shown in the drawings and/or discussed herein are non-exclusive and that there are other examples of how the disclosure may be practiced.

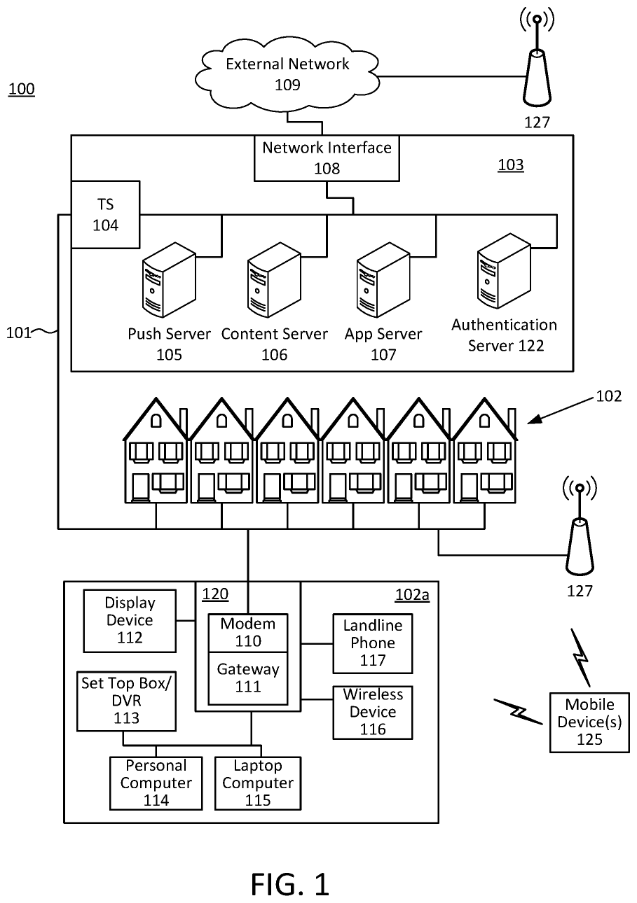

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not illustrated, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104, such as a termination system (TS). The interface 104 may comprise a cable modem termination system (CMTS) and/or other computing device(s) configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The local office 103 may comprise one or more network interfaces 108 that comprise circuitry needed to communicate via the external networks 109. The external networks 109 may comprise networks of Internet devices, telephone networks, wireless networks, wireless networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the authentication server 122 (described below), additional push, content, and/or application servers, and/or other types of servers. Although shown separately, the push server 105, the content server 106, the application server 107, the authentication server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), STBs or DVRs 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g. Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

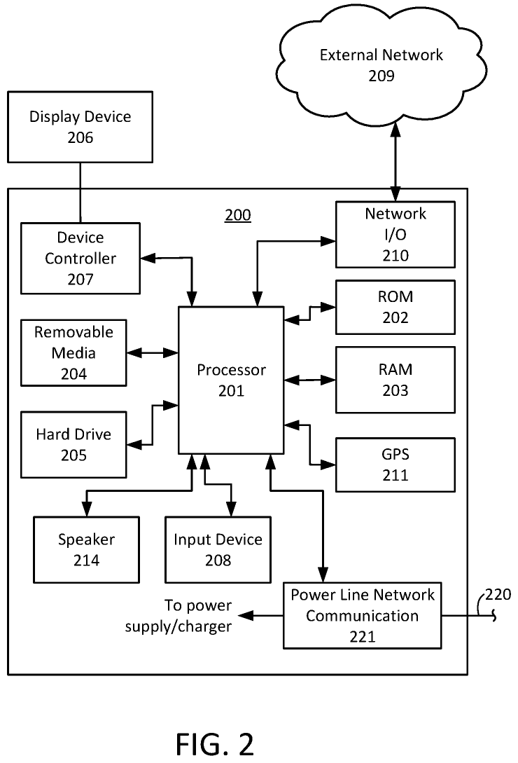

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., any of the user devices 301-303, the computing device 308, the mobile device 701). The computing device 200 may comprise one or more processors 201, which may execute instructions of a computer program to perform any of the functions described herein. The instructions may be stored in a read-only memory (ROM) 202, random access memory (RAM) 203, removable media 204 (e.g., a USB drive, a compact disk (CD), a digital versatile disk (DVD)), and/or in any other type of computer-readable medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

The computing device 200 may also comprise circuitry 221 configured to receive and/or send communications via a power line network. A power cord 220 may be connectable to an outlet or other source of electrical power so as to deliver a power signal (e.g., a 120 volt, 60 Hz AC signal) to an internal battery supply and/or charger (not shown) of the computing device 200. The circuitry 221 may comprise a filter that can detect communication signals added to the power signal and carried via a power line. The circuitry 221 may also or alternatively comprise a signal generator to generate a communication signal and add that communication signal to a power signal for transmission via a power line.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

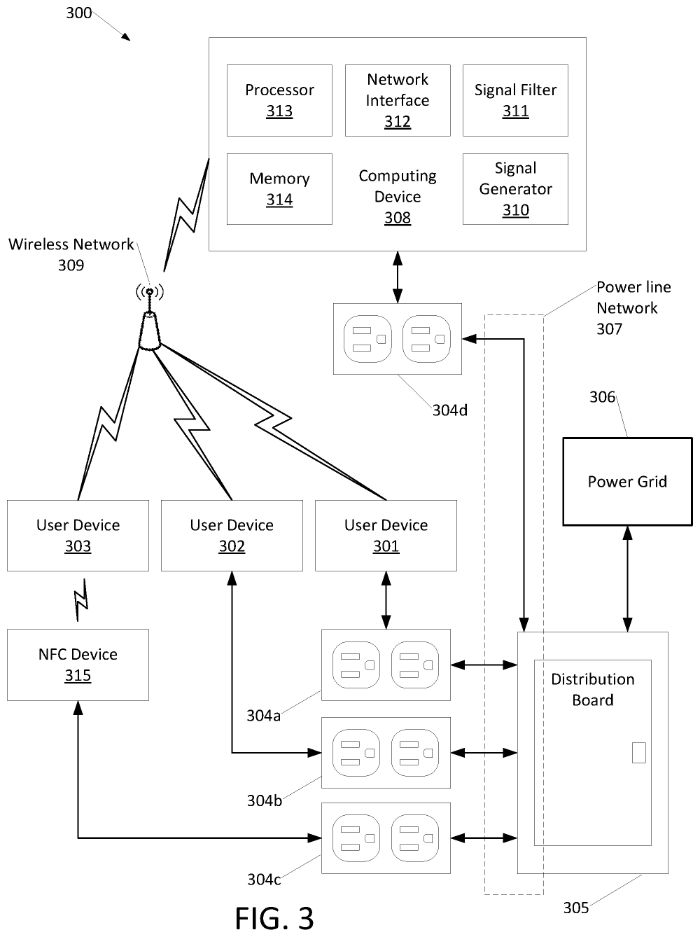

An example premises 300 is shown and described with reference to FIG. 3. The premises 300 may be a premises similar to the premises 102a of FIG. 1 and may comprise elements such as some or all of the elements described above and in FIG. 1 in connection with the premises 102a. The premises 300 may comprise one or more user devices 301, 302, and 303, as well as a computing device 308. The computing device 308 may be, e.g., the gateway 111 or one of the other computing devices described in connection with the premises 102a, or may be another computing device. Each of the user devices 301-303 may also be a computing device. For convenience, however, the user devices 301-303 will be referred to as user devices in several examples. Each of the user devices may be any of the devices shown in the premises 102a (e.g., the personal computer 114, the laptop computer 115, the wireless device 116), the wireless device 125, or another type of computing device. Additional examples of types of computing devices that could be comprised by one of the user devices 301-303 comprise cameras (e.g., security cameras), home automation devices (e.g., devices to facilitate remote control of light switches, power outlets, thermostats, door locks, etc.), smart appliances, or any other type of computing device.

The user devices 301-303 may be connected to a power supply such as, for example, via one or more power outlets 304a, 304b, 304c. The power supply may comprise inductive charging pads plugged into the one or more power outlets 304a, 304b, 304c. The one or more user devices 301, 302, 303 may comprise batteries such that the one or more user devices 301, 302, 303 may not always be plugged into a power source.

The power outlets 304a, 304b, 304c may be electrically connected to other outlets (e.g., 304d) within the premises 300 via a distribution board 305 (e.g., an electric/breaker panel). The power outlets 304a, 304b, 304c, 304d may be connected to a power grid 306 (e.g., the public power grid) via the distribution board 305. Electrical wires connected to the power outlets 304a, 304b, 304c, 304d may, in addition to serving as ground wires and/or carrying electricity for purposes of supplying a power signal, act as transmission media for communication of signals in a power line network 307.

The power line network 307 may enable communication between multiple devices within the premises 300 such as, for example, the one or more user devices 301, 302, and 303 and/or the computing device 308. The computing device 308 may be part of the distribution board 305, may be a standalone device located within the premises 300 with access to the power line network 307 (e.g., via power outlet 304d), or may be part of a network device located within the premises 300 such as, for example, the gateway 111 of FIG. 1. The power line network 307 may utilize existing electrical wiring within the premises 300, which may be separated from a power grid 306 via the distribution board 305, to create a localized network of devices. The power line network 307 may be secured from outside intruders based on the utilization of the physical connection to the electrical powers wires within the premises 300 (e.g., by connection to one or more of power outlets 304a, 304b, 304c, 304d).

The computing device 308 may also communicate with the one or more user devices 301, 302, and 303, and/or with other devices, via a wireless network 309. The computing device may also control access to the wireless network 309 by, e.g., blocking or limiting (throttling) communications via the wireless network 309.

As discussed below, the computing device 308 may cause a signal indicating an access code to be transmitted via the power line network 307. An access code signal may be able to traverse circuit breakers (e.g., in the distribution board 305, in a junction box, and/or another electrical/breaker panel) if those circuit breakers are not opened (or tripped). If a circuit breaker is tripped, the power line network 307 may be segmented such that power supplies (e.g., outlets) on the circuit associated with the tripped circuit breaker may not be able to communicate with other circuits. The power supplies (e.g., outlets) on the circuit associated with the tripped circuit breaker may enable communication among devices on the tripped circuit (e.g., devices using alternate power sources such as, for example, batteries) until the circuit associated with the tripped circuit breaker is reconnected to the other circuits (e.g., by resetting the tripped circuit breaker). Multiple smaller power line networks may be established while circuit breakers are tripped.

Communication between devices associated with different circuits and/or disconnected due to tripped circuit breakers may be enabled using one or more other communication protocols other than power line networking. For example, wireless (e.g., Bluetooth, ZigBee, Wi-Fi, Li-Fi, NFC), wired (e.g., Ethernet, MoCA, fiber optics), or other known communication protocols may be used to communicate with one or more devices within a premises if a circuit is tripped. Such additional communication protocols may be used as a backup to the power line communications. A device may be configured to only communicate, via these additional communication protocols, with devices that have previously communicated with the device. Access codes and/or other signals may be communicated between devices on different circuits.

Communication may further be facilitated across different power phases (e.g., three phase power, dual phase power, single phase power) via power line phase couplers. A power line phase coupler may be installed (e.g., at the distribution board 305) and may create a connection between different power phases such that communications on a first phase may be able to traverse to a second phase. Power line phase couplers may include or may be used with optical couplers for bridging across power line legs in a premises.

The computing device 308 may comprise a signal generator 310, a signal filter 311, a network interface 312, a processor 313, and memory 314. The signal generator 310 may be configured to generate and provide a unique access code to devices in communication with the power line network 307. The unique access code may be a digital or analog signal that is added to the alternating current power signal coming from the power company via the power grid 306. For example, the access code may be a pulse such as a low frequency (e.g., <60 Hz) square wave generated by the signal generator 310. Alternatively, the access code may be a high frequency (e.g., >60 Hz) pulse. The unique access code may be a signal code specific to the premises 300, may be one of a plurality of unique access codes specific to the premises 300 that the signal generator 310 of the computing device 308 algorithmically selects, or may be an access code that the signal generator 310 temporarily and randomly generates. The access code may be a hashed version of an address of the computing device 308. For example, the access code may be a hash of a media access control (MAC) address of a gateway device. The authentication server 122 may be configured to remotely perform one or more of the capabilities of the computing device 308 (e.g., as a cloud based computing device 308).

Each of the one or more user devices 301, 302, 303 may comprise, or may be in communication with, circuitry that detects communication signals (e.g., comprising access codes) transmitted via the power line network 307. That circuitry may comprise one or more filters. For example, the one or more user devices 301, 302, 303 may have power converters with one or more filters built therein. The one or more power outlets 304a, 304b, 304c, 304d may themselves comprise one or more filters. The one or more filters may separate the communication signals carrying access codes from the power supply signals so that the one or more user devices 301, 302, 303 may be powered and/or may obtain access codes to provide during authentication as further described herein. The one or more filters may further account for noise or other interference on the power line network 307.

As described above, the one or more user devices 301, 302, 303 may not always be plugged into a power source and thus, may not always be in communication with the power line network 307. The one or more user devices 301, 302, 303 may store, after the one or more user devices 301, 302, 303 are disconnected from the power source, the unique access code(s) identified on the power line while connected to the power source.

The signal generator 310 of the computing device 308 may generate a new access code according to a schedule. For example, the computing device 308 may determine a maximum battery life of one of the user device 301, 302, 303 and the signal generator 310 may generate an access code at an interval defined by a time associated with depletion of the maximum battery life of the one of the user devices 301, 302, 303 (e.g., if a user device has a maximum battery life of 16 hours, the signal generator 310 may generate a new access code every 16 hours). The one of the user devices 301, 302, 303 may receive a new access code when, to recharge the battery, the one of the user devices 301, 302, 303 is plugged into one of the power outlets 304a, 304b, 304c, 304d of the premises.

The signal filter 311 may be configured to prevent information that is sent over the power line network of the premises (e.g., the unique access code generated by the signal generator 310) from exiting the premises 300 via the main power line that may be connected to the grid. For example, the signal filter 311 may be configured to filter out access codes and prevent neighboring premises (or other parties outside the premises) from being able to acquire such access codes. The signal filter 311 may comprise a high pass filter, a low pass filter, a band-stop filter, a band-pass filter, or any combination thereof. The signal filter 311 may comprise a multimedia over coax alliance (MoCA) filter. The signal filter 311 may be located at the distribution board 305.

The processor 313 may be configured to execute instructions stored by memory 314. Memory 314 may comprise one or more computer readable storage media. Memory 314 may comprise a behavior database associating identifiers, models, or device IDs of devices with expected behaviors of the devices. For example, the behavior database may comprise an entry associating a MAC address of a device with a known data transfer frequency of one kilobit per hour (kb/hr).

The network interface 312 may be configured to communicate via the wireless network 309 or the power line network 307. The network interface 312 may be configured to monitor the behavior of devices communicating via the wireless network 309. The network interface 312 may access the memory 314 to compare monitored behavior of the devices communicating via the wireless network 309 with known expected behaviors for such devices (e.g., stored in the behavior database of the memory 314). For example, the network interface 312 may receive an identifier of a device (e.g., a MAC address) and search the database of the memory 314 for behavior associated with that identifier. The network interface 312 may, based on the comparison, adjust network access for the devices (e.g., continue to allow, throttle, block access, or request a user to decide how to handle network access).

For example, if the monitored behavior of the user device 301 is sixty kb/hr and the normal behavior of the user device 301 is one kb/hr (as indicated in the behavior database), the computing device 308 may determine that the monitored behavior of the user device 301 does not correspond with the normal behavior of the user device 301. The computing device 308 may determine that the monitored behavior of the user device 301 does not correspond with the normal behavior of the user device 301 by monitoring the types of data sent/received, the volume of data sent/received, the times of day that data is sent/received, the addresses to which data is sent, or the addresses from which data is received.

In operation, when one or more of the user devices 301, 302, 303 attempt to gain access to the wireless network 309, the computing device 308 may request that the one or more user devices 301, 302, 303 provide an access code generated by the computing device 308 (previously generated or generated after the one or more user devices 301, 302, 303 attempt to gain access to the wireless network 309). If the one or more user devices 301, 302, 303 are connected to the power line network 307 or subsequently connect to the power line network 307 (e.g., via the one or more power outlets 304a, 304b, 304c, 304d), the one or more user devices 301, 302, 303 may be able to obtain the access code from the power line network 307, store the access code, and provide, to the computing device 308, the access code to gain access to the wireless network 309. The one or more user devices 301, 302, 303 may acquire the access code prior to or in response to a request from the computing device 308 for that access code. If the requested access code is not provided (e.g., after a threshold amount of time), the computing device 308 may deny the one or more user devices 301, 302, 303 access to the wireless network 309 or may throttle/limit access of the one or more user devices 301, 302, 303 to the wireless network 309.

The one or more user devices 301, 302, 303 may comprise removable batteries that either are non-rechargeable or that are recharged via a device separate from the user devices 301, 302, 303, such that the user devices 301, 302, 303 may not require direct connection to the power line network 307. For example, the user device 303 may connect to the power line network 307 via another device that is connected to the power line network. A near field communication (NFC) device 315 may be used to transfer an access code, received via the power line network 307, to the user device 303. The user device 303 may communicate the access code during some or all of its communications over the wireless network 309 so that the computing device 308 may determine that the user device 303 has not been authenticated with a different network (e.g., before or after authentication with the wireless network 309). Battery operated devices with low data rates may authenticate less frequently than devices with large data rates to preserve battery capacity. Larger data rate devices, including battery operated devices, may authenticate more frequently. If any of the one or more user devices 301, 302, 303 has been authenticated with a different network, the computing device 308 may contact that different network when the one or more user devices 301, 302, 303 attempt to connect with the wireless network 309.

The NFC device 315 may comprise power charging capabilities for user devices with non-removable batteries. The one or more user devices 301, 302, 303 may connect to another device connected to the power line network via other short range protocols such as, for example, infrared data association (IrDA), and/or physical connectors such as, universal serial bus (USB).

The user device 303 may communicate, via the NFC device 315, with the computing device 308 to authenticate and gain access to the wireless network 309. Visual indicators on the NFC device 315, such as red, yellow, and green light emitting diodes (LEDs), may confirm, to a user, that the user device 303 is denied access, is provided limited access, or is granted access (respectively).

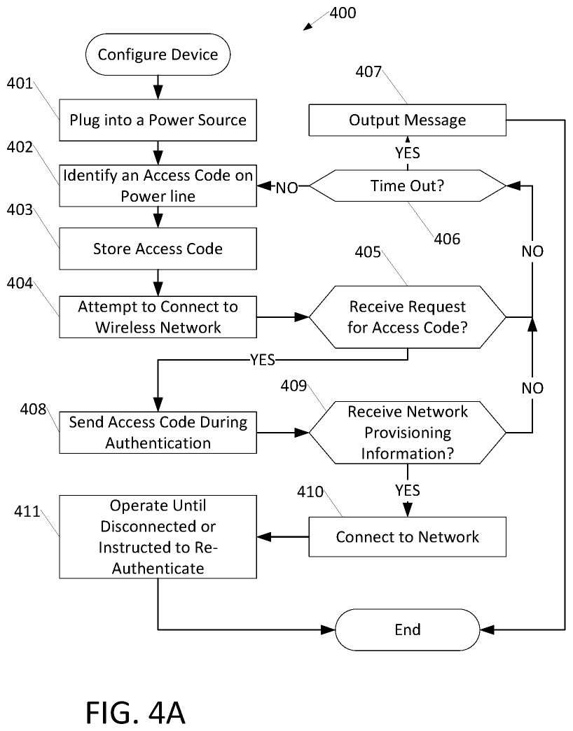

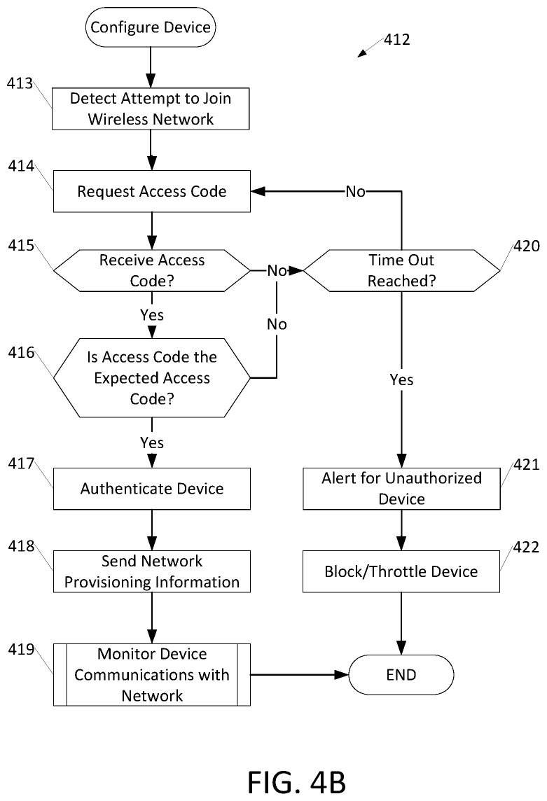

FIG. 4A is a flow chart showing an example method of a user device attempting to authenticate to gain access to the wireless network 309. The method 400 may begin by configuring a user device (e.g., the user device 301).

The user device 301 may, in association with an initial set-up of the user device 301, in association with powering up the user device 301, and/or in association with relocating the user device 301, plug into a power source such as, for example, the power outlet 304a (step 401). The user device 301 may identify a unique access code transmitted via the power line in addition to the power supply signal (step 402). For example, the user device 301 may filter the unique access code from the power supply signal during conversion (e.g., alternating current to direct current (AC-DC) or direct current to direct current (DC-DC)) of the power supply signal. The user device 301 may store the unique access code (step 403). The user device 301 may continue to identify and store unique access codes on the power line should the unique access codes vary over time.

The user device 301 may attempt to connect to the wireless network 309 (step 404). The wireless network 309 may be open (e.g., not password protected) or secure (e.g., password protected). The user device 301 may receive, via the wireless network 309 and in response to its attempt to connect to the wireless network 309, a request for an access code (step 405). If the user device 301 does not receive a request for an access code step (step 405: NO), a threshold amount of time may pass before a time out occurs (step 406). If a time out has not occurred (step 406: NO), the user device 301 may re-attempt to connect to the wireless network with a same or different access code (step 402). If a time out has occurred (step 406: YES), a message may be output of the user device 301 (step 407). The message may indicate a time out has occurred, the attempt to connect to the wireless network has been unsuccessful, the user device 301 should re-attempt connection, access to the wireless network 309 has been denied, blocked, or throttled, etc.

If the user device 301 does receive a request for an access code (step 405: YES), then the user device 301 may send the unique access code identified on the power line to the computing device 308 in response to the access code request by the computing device 308 (step 408). The user device may determine if network provisioning information has been received from computing device 308 (step 409). If the user device 301 does not receive network provisioning information (step 409: NO), another time out evaluation may be performed (step 406). A threshold amount of time used for the evaluation in step 406 may differ depending on whether step 406 is reached from step 405 or from step 409. If the user device 301 receives network provisioning information (step 409: YES), the user device 301 may connect to the wireless network 309 (step 410). The user device 301 may operate until it disconnects from wireless network 309 or until it is instructed to re-authenticate (step 411). If instructed to re-authenticate, the user device 301 may repeat the method starting at step 402. The method 400 may cease operation. Method 400 may be performed again, continuously, or periodically.

FIG. 4B is a flow chart showing an example method 412 of a computing device (e.g., computing device 308) authenticating a device (e.g., user device 301) in response to a network access request. The method 412 may begin by configuring computing device 308. For example, the computing device 308 may generate a unique access code and transmit that access code via the power line network 307 during configuration. The computing device 308 may generate and/or transmit a unique access code via the power line network 307 at any time. The computing device 308 may, for example, transmit an access code via the power line network 307 at periodic intervals and/or in conjunction with other operations of step 414 (described below).

The computing device 308 may detect an attempt to join wireless network 309 (step 413). The computing device 308 may request, via the wireless network 309, an access code from the user device 301 (step 414). The computing device 308 may determine if it has received the requested access code (step 415). If the computing device 308 receives an access code (step 415: YES), the computing device 308 may compare the received access code to an expected access code (e.g., to the access code transmitted as part of step 414 and/or periodically) and determine whether the received access code is the same as the expected access code (step 416). If the computing device 308 determines that the received access code is the same as the expected access code (step 416:YES), the computing device 308 may authenticate the user device 301 (step 417). The computing device 308 may retrieve an identifier of the user device 301 to authenticate the user device 301. The identifier of the user device 301 may comprise a MAC address, which may comprise an organizationally unique identifier (OUI) (e.g., an identifier of a manufacture) and a device identifier (e.g., a model/device identifier or an identifier of a network interface controller (NIC)). The computing device 308 may generate a secure or demilitarized zone (DMZ) network including the user device 301 or may add the user device 301 to an existing DMZ network. The computing device 308 may request device authentication any time a device attempts to access the secure or DMZ network.

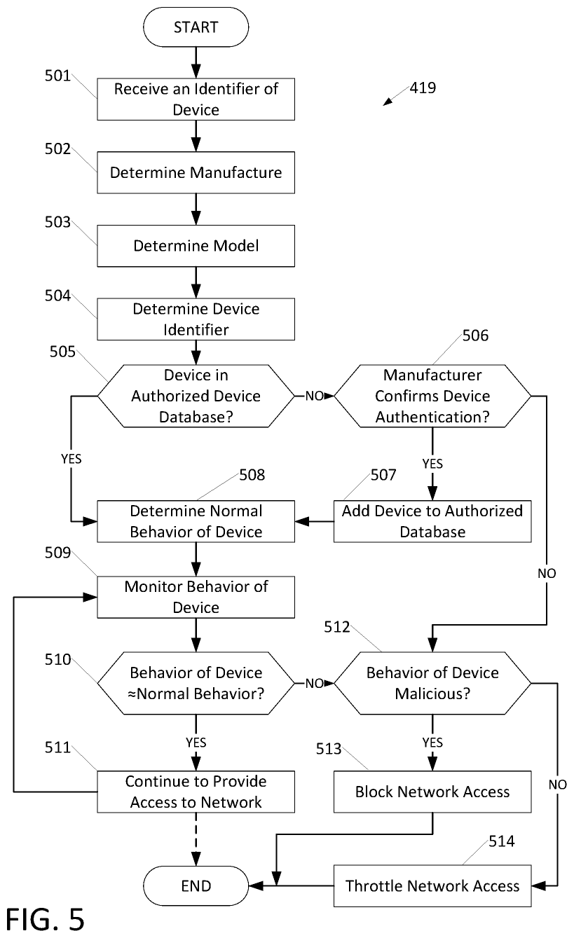

The computing device 308 may provide the user device 301 access to the wireless network 309 by sending network provisioning information to the user device 301 (step 418). The computing device 308 may monitor the network activity of the user device 301 on the wireless network 309 and/or the behavior of the user device 301 (step 419). The monitoring of step 419 is described in connection with FIG. 5. Step 419 may be performed until one or more conditions or events occurs. Non-limiting examples of such conditions or events may include: detecting unusual, unexpected, and/or unwanted behavior from the user device 301; expiration of a preset period of time during which the user device 301 is to be allowed access to the wireless network 309 (e.g., a time corresponding to a periodic requirement for re-authentication); and/or non-receipt of a heartbeat or other signal from the user device 301 (which non-receipt may, e.g., be indicative of the user device 301 going off-line). When step 419 terminates, the method 412 may end. Method 412 may be performed again, continuously, or periodically.

If the computing device 308 has not received an access code (step 415: NO) or if the computing device 308 does not receive an access code that matches the expected access code (step 416: NO) within a threshold amount of time, the computing device 308 may determine a time out has occurred (step 420). If the computing device 308 determines that the threshold amount of time has not passed (step 420: NO), the computing device 308 may re-request the access code from the user device 301 (step 414). If the computing device 308 determines that the threshold amount of time has passed (step 420: YES), the computing device 308 may generate an alert indicating the user device 301 is a suspicious or unauthorized device (step 421). The computing device 308 may further deny, block, or throttle access to the wireless network 309 for the user device 301 (step 422). The method 412 may cease operation. Method 412 may be performed again, continuously, or periodically.

FIG. 5 is a flow chart showing an example method of implementing step 419 of FIG. 4B to monitor network activity and/or behavior of a user device on a wireless network. In the example of FIG. 5, the steps of the method 419 are performed by the user device 308 in connection with the user device 301 and the wireless network 309. However, some or all of the steps of the method 419 could be performed by one or more other computing devices and/or in connection with one or more other monitored computing devices and/or in connection with one or more other networks.

The computing device 308 may receive, from the user device 301, an identifier (e.g., MAC address) of the user device 301 (step 501). The computing device 308 may receive the identifier of the user device 301 when the user device 301 attempts to connect to the wireless network 309. The computing device 308 may determine, based on the received identifier, a manufacturer of the user device 301 (step 502). For example, the computing device 308 may access an OUI lookup service such as, for example, the Wireshark® OUI lookup tool.

The computing device 308 may determine, based on the received identifier, a model of the user device 301 (step 503). The computing device 308 may determine, based on the received identifier, a device identifier (ID) (e.g., serial number) of the user device 301 (step 504). The computing device 308 may check a database (e.g., within memory 314), which may comprise a list of authorized devices and associated identifiers, models, or device IDs, to determine whether the received identifier associated with the user device 301 has been previously authorized or otherwise identified as non-malicious (step 505).

If the computing device 308 determines that the received identifier associated with the user device 301 is not within the database (step 505: NO), the computing device 308 may contact, via a secure connection, another computing device (associated with the manufacturer of the user device 301) to confirm whether the identifier associated with the user device 301 is a valid identifier associated with a manufacturer (step 506). If the manufacturer of the user device 301 confirms that the user device 301 is a valid identifier associated with the manufacturer (step 506: YES), the computing device 308 may add an indication of the user device 301 and its associated identifier, model, and/or device ID to the database (step 507). If the manufacturer of the user device 301 does not confirm the user device 301 is a valid identifier associated with the manufacturer (step 506: NO), the computing device 308 may determine that the identifier of the user device 301 has been spoofed and/or that some other anomalous condition has occurred.

If the computing device 308 determines that the received identifier associated with the user device 301 is within the database (step 505: YES), the computing device 308 may determine, based on the received identifier, the manufacturer, the model, and/or the device ID, what is the normal behavior of the user device 301 (step 508). For example, normal behavior for a smart thermostat may comprise an exchange of information (e.g., over the wireless network 309) at a rate of one message every five minutes or 1 kb/hr.

The computing device 308 may monitor the behavior of the user device 301 (step 509). For example, the monitored behavior of the user device 301 may comprise an exchange of information at sixty kb/hr. The computing device 308 may determine whether the monitored behavior of the user device 301 corresponds with the normal behavior of the user device 301 (step 510). If the computing device 308 determines that the monitored behavior of the user device 301 corresponds with the normal behavior of the user device 301 (step 510: YES), the computing device 308 may continue to provide the user device 301 access to the wireless network 309 (step 511) and may continue to monitor the behavior of the user device 301 (step 509). If the computing device 308 determines that the monitored behavior of the user device 301 does not correspond with the normal behavior of the user device 301 (step 510: NO) or if the manufacturer of the user device 301 does not confirm the user device 301 is a valid identifier, the computing device 308 may determine whether the monitored behavior of the user device 301 appears to be malicious (step 512). For example, if the monitored behavior of the user device 301 is sixty kb/hr and the normal behavior of the user device 301 is one kb/hr, the computing device 308 may determine that the monitored behavior of the user device 301 does not correspond with the normal behavior of the user device 301. The computing device 308 may determine that the monitored behavior of the user device 301 does not correspond with the normal behavior of the user device 301 using additional behavior attributes including, without limitation, the types of data sent/received, volume of data sent/received, times of day that data is sent/received, and/or the address(es) to which data is sent or from which data is received.

The computing device 308 may determine whether the behavior of the user device 301 is malicious by comparing the monitored behavior of the user device 301 to known malicious behavior. For example, the authentication server 122 may comprise a database including known malicious addresses, known malicious data types, virus signatures/definitions, etc. that may be accessed by the network interface 312 or stored within the memory 314.

If the computing device 308 determines that the monitored behavior of the user device 301 is malicious (step 512: YES), the computing device 308 may block the user device 301 from accessing the wireless network 309 (step 513). The computing device 308 may protect the wireless network 309 from a malicious device. If the computing device 308 determines that the monitored behavior of the user device 301 is not malicious (step 512: NO), the computing device 308 may throttle or limit access to the wireless network 309 for the user device 301 (step 514). The computing device 308 may minimize the network impact of an abnormal or faulty device. The method 419 may cease operation after any of steps 511, 513, or 514. Method 419 may be performed again, continuously, or periodically.

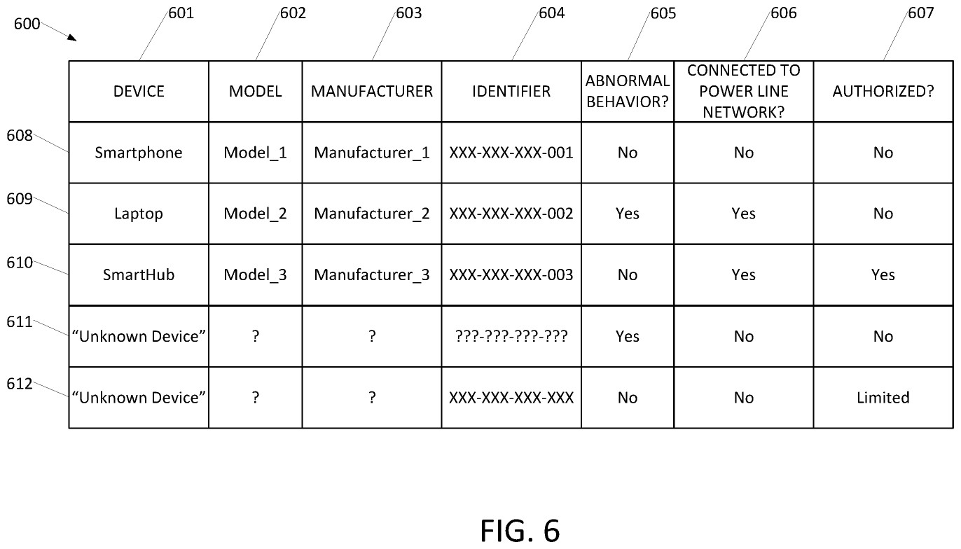

FIG. 6 shows an example table 600 comprising indications of a plurality of devices 601, indications of corresponding models 602 of the plurality of devices 601, indications of corresponding manufacturers 603 of the plurality of devices 601, indications of corresponding identifiers 604 of the plurality of devices 601, indications of whether the plurality of devices 601 are exhibiting abnormal behavior 605, indications of whether the plurality of devices 601 are connected to a power source 606, and indications of whether the plurality of devices 601 are authorized 607 to access the wireless network 309.

A first device of the plurality of devices 601 may be a smartphone 608. The smartphone 608 may be a first model from a first manufacturer with a first identifier. Based on the first identifier, as described above, the computing device 308 may determine the normal behavior of the smartphone 608 and whether the monitored behavior of the smartphone 608 corresponds with that normal behavior. For example, the computing device 308 may determine that the smartphone 608 is not exhibiting abnormal behavior. The computing device 308 may determine whether the smartphone 608 is connected to the power line network 307 such that the smartphone 608 may provide an access code sent over the power line network 307. For example, the computing device 308 may determine that the smartphone 608 is not connected to the power line network 307 by requesting the access code and not receiving the access code. If the computing device 308 does not receive the access code from the smartphone 608, the computing device 308 may not authorize the smartphone 608 to access the wireless network 309. The computing device 308 may request that the smartphone 608 connect to the power line network 307 and re-request the access code. If the smartphone 608 is able to provide the access code within a threshold amount of time, the computing device 308 may grant the smartphone 608 access to the wireless network 309.

A second device of the plurality of devices 601 may be a laptop computer 609 with a second model, a second manufacturer, and a second identifier. Based on the second identifier, the computing device 308 may determine the normal behavior of the laptop computer 609 and whether the monitored behavior of the laptop computer 609 corresponds with that normal behavior. For example, the computing device 308 may determine that the laptop computer 609 is exhibiting abnormal behavior. The computing device 308 may determine not to authorize the laptop computer 609 for access to the wireless network 309 based solely on the abnormal behavior. The computing device 308 may determine whether the laptop computer 609 is connected to the power line network 307 such that the laptop computer 609 may provide an access code sent over the power line network 307. Even if the laptop computer 609 is able to provide the access code to the computing device 308, the computing device 308 may not authorize the laptop computer 609 access to the wireless network 309 based on abnormal behavior.

A third device of the plurality of devices 601 may be a smart hub 610 with a third model, a third manufacturer, and a third identifier. Based on the third identifier, the computing device 308 may determine the normal behavior of the smart hub 610 and whether the monitored behavior of the a smart hub 610 corresponds with that normal behavior. For example, the computing device 308 may determine that the smart hub 610 is not exhibiting abnormal behavior. The computing device 308 may determine that the smart hub 610 is connected to the power line network 307 when the smart hub 610 provides an access code sent over the power line network 307. The computing device 308 may authorize the smart hub 610 access to the wireless network 309.

A fourth device of the plurality of devices 601 may be an unknown device 611 and a fifth device of the plurality of device 601 may be an unknown device 612. The unknown device 611 may obfuscate its identifier such that the computing device 308 may not determine the model or manufacturer of the unknown device 611. The identifier of the unknown device 612 may not be within the behavior database of known identifiers and devices, such that the computing device 308 may not be able to determine the model, the manufacturer, or the normal behavior of the unknown device 612. In order to determine whether the behavior of the unknown device 611 or the unknown device 612 is abnormal, the computing device 308 may compare the behavior of the unknown device 611 or the unknown device 612 to known malicious behaviors (e.g., the behavior of known malware, viruses, DDoS attackers, etc.). The computing device 308 may determine that the unknown device 611 is exhibiting abnormal behavior, but the unknown device 612 is not exhibiting abnormal behavior. The computing device 308 may block the unknown device 611 from the wireless network 309. The computing device 308 may grant the unknown device 612 limited access to the wireless network 309. The computing device 308 may grant the unknown device 612 full access to the wireless network 309 if the computing device 308 may determine the normal behavior of the unknown device 612 (e.g., based on the identifier and/or based on monitoring the limited access behavior over time) and if the unknown device 612 is able to provide an access code sent via the power line network 307.

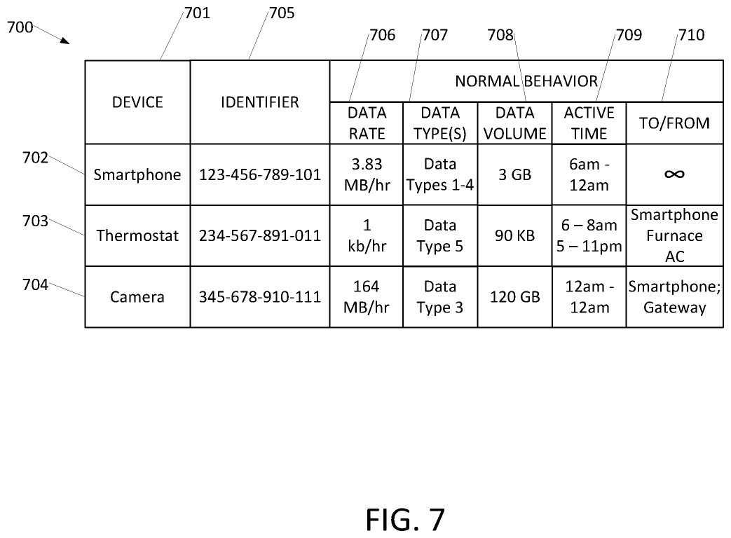

FIG. 7 shows an example table 700 comprising data within the behavior database within the memory 314. The example table 700 may comprise indications of a plurality of devices 701, such as, for example, a smartphone 702, a thermostat 703, and a camera 704, indications of corresponding identifiers 705, and indications of normal behavior such as data rates 706, known data types 707, data volumes 708, active times 709, and to/from addresses 710. For example, the smartphone 702 may be associated with a first identifier 123-456-789-101, a normal data rate of 3.83 MB/hr, multiple data types 1-4, a data volume of 3 GB, active times between 6 am-12 am (e.g., associated with times a user is awake), and any number of addresses to send and receive data from. The thermostat 703 may be associated with a second identifier 234-567-891-011, a data rate of 1 kb/hr, data type 5, a data volume of 90 KB, active times between 6 am-8 am and 5 pm-11 pm (e.g., associated with times a user is home), and address(es) to which data may be sent and/or from which data may be received from (e.g., address(es) of a smartphone, a furnace, and an air condition (AC) unit). The camera 704 may be associated with a third identifier 345-678-910-111, a data rate of 164 MB/hr, data type 3, a data volume of 120 GB, active times between 12 am-12 am (e.g., all day recording), and a select number of addresses to send and receive data from (e.g., smartphone, gateway).

The computing device 308 may determine whether the monitored data rate, data types, data volume, active times, or to/from addresses associated with a device vary from the normal behavior within the behavior database as represented by example table 700. The computing device 308 may allow for a threshold amount of variance such that the monitored behavior of the device need not match the normal behavior exactly. For example, the data rate or data volume may be within +/−20% of the normal behavior. After, or in response to, determining that monitored behavior of a device exceeds a threshold variance of normal behavior, the computing device 308 may automatically block, throttle, and/or remove the device from the wireless network 309 or any secure/DMZ network to which the device attempted to connect and/or previously belonged.

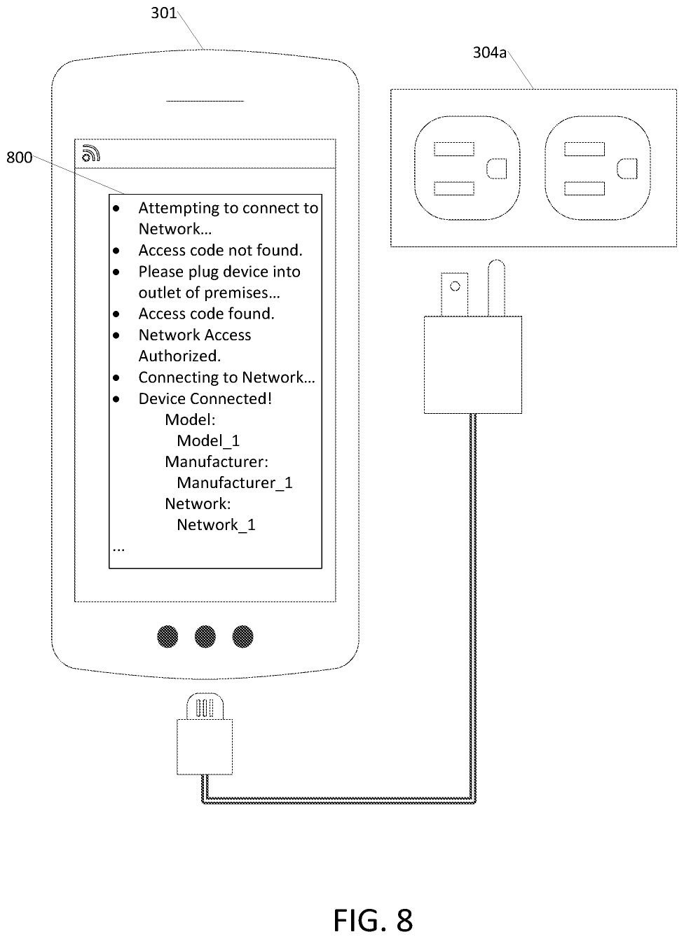

FIG. 8 shows an example graphical user interface (GUI) 800 for a user device (e.g., the user device 301). As described herein, the user device 301 may not always be connected to a power supply (e.g., power outlet 304). Although the user device 301 may identify an access code on the power line network 307 (not shown) if it is plugged into the power outlet 304, the computing device 308 may, after the user device 301 has been removed from the power outlet 304, change the access code (e.g., accordingly to a predetermined schedule, in response to wireless network access requests, etc.). Accordingly, the GUI 800 on the user device 301 may output, to the user of the user device 301, one or more indications to facilitate network connections. For example, the GUI 800 may output a first indication such as, “Attempting to connect to Network . . . ” The user device 301 may attempt to authenticate with the computing device 308 using an access code, if any, stored on the user device 301 (or in cloud-based storage). The GUI 800 may output a second indication such as, “Access code not found,” if the user device 301 does not have an access code, a most recent access code is not valid (e.g., if the user device 301 has an outdated access code), and/or after a threshold amount of time has elapsed. The GUI 800 may subsequently output a third indication such as, “Please plug device into outlet of premises . . . ” to instruct a user to connect the user device 301 to the power line network 307 (e.g., via the power outlet 304a) to receive the access code. The computing device 308 may authenticate the user device 301 based on the access code and/or an identifier of the user device 301. The GUI 800 may output fourth and fifth indications such as, “Network Access Authorized.” and “Connecting to Network . . . ” The user device 301 and the computing device 308 may negotiate network provisioning instructions and the user device 301 may connect to the wireless network 309. The GUI 800 may output a sixth indication such as “Device Connected!” The GUI 800 may further output a seventh indication including the data exchanged such as the model and the manufacturer of the user device 301, the network name, the time of connection, etc. A user of the user device 301 may have an option to bypass the aforementioned localized multi-factor network authentication for devices known to be secure/authentic.

After the one of more user devices 301, 302, 303 have been authenticated with the wireless network 309, the one or more user devices 301, 302, 303 may be used more securely with and around the wireless network 309. For example, a security system for a premises may be connected to the wireless network 309 and the one or more user devices 301, 302, 303 may be able to arm or disarm the security system. The one or more user devices 301, 302, 303 may arm or disarm the security system based on the one or more user devices 301, 302, 303 being within a given range (e.g., within range of a NFC device connected with the power line network 307).

The computing device 308 may be configured to cause transmission of a same access code onto a power line network, even where the computing device 308 is moved to a new premises (e.g., due to the user moving to a new location). The computing device 308 may be configured to communicate with devices previously allowed access to the wireless network 309 to determine whether those devices were also moved to the new premises. For example, while a user may bring a gateway device to a new premises, the user may not bring a smart refrigerator to the new premises. The computing device 308 may identify moved devices as those that were previously authenticated and continue to communicate or connect with the wireless network 309; the computing device 308 may identify non-moved devices as those that were previously authenticated and are no longer communicating or attempting to connect to the wireless network 309. The computing device 308 may maintain the authentication of devices which the computing device 308 determines have been moved to the new premises and are connected to a new power line network. The computing device 308 may communicate, via a network such as the Internet and with devices which the computing device 308 determined have not been moved to the new premises, instructions to remove previous authentications and access to the wireless network 309. Devices that have had authentications and/or access to the wireless network 309 removed may re-authenticate upon connection with the new power line network.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

We claim:

1. A method comprising:
causing, by a first computing device associated with a wireless network, transmission, via a premises power line network, of an access code;
receiving, from a second computing device, a request to access the wireless network;
sending, to the second computing device, a request for the access code; and
after receiving the access code from the second computing device, sending, to the second computing device, information for accessing the wireless network.

2. The method of claim 1, wherein the request to access the wireless network comprises an identifier of the second computing device, the method further comprising:
authenticating, based on the identifier, the second computing device.

3. The method of claim 1, wherein the request to access the wireless network comprises an identifier of the second computing device, the method further comprising:
determining, based on the identifier, a manufacturer of the second computing device;
retrieving a list of device identifiers; and
determining, based on the identifier and on the list of device identifiers, whether the identifier is a valid identifier.

4. The method of claim 1, wherein the request to access the wireless network comprises an identifier of the second computing device, the method further comprising:
determining, based on the identifier, information indicating expected behavior of the second computing device.

5. The method of claim 4, further comprising:
monitoring behavior of the second computing device; and
determining, based on the monitored behavior of the second computing device and on the information indicating expected behavior of the second computing device, that access to the wireless network should be blocked.

6. The method of claim 1, wherein the access code comprises a hash of a media access control address of the first computing device.

7. The method of claim 1, further comprising:
denying, based on a failure to receive the access code from a third computing device, access by the third computing device to the wireless network.

8. The method of claim 1, wherein the premises power line network is one of a plurality of premises power line networks within a single premises.

9. A method comprising:
sending, by a first computing device and to a second computing device, a request to access a wireless network;
receiving, from the second computing device, a request for an access code;
determining, based on a communication signal received via a premises power line network, the access code;
sending, to the second computing device, the access code; and
receiving, from the second computing device, information for accessing the wireless network.

10. The method of claim 9, further comprising:
receiving, from a third computing device, a request for a second access code different from the access code; and
determining, based on a second communication signal received via a second power line network different from the premises power line network, the second access code.

11. The method of claim 9, further comprising:
sending, by the first computing device and to a third computing device, a request to access a second wireless network different from the wireless network; and
receiving, from the third computing device and based on the first computing device failing to provide a second access code associated with the second wireless network, a message denying access to the second wireless network.

12. The method of claim 9, further comprising:
sending, by the first computing device and to a third computing device, a request to access a second wireless network different from the wireless network; and
receiving, from the third computing device and based on the first computing device failing to provide a second access code associated with the second wireless network, limited access to the second wireless network.

13. The method of claim 9, wherein a connection to the premises power line network comprises an inductive connection.

14. The method of claim 9, further comprising:
after receiving the request for the access code, receiving, from the second computing device, an instruction to connect the first computing device to a power supply.

15. The method of claim 9, wherein the premises power line network is one of a plurality of premises power line networks within a single premises.

16. A method comprising:
receiving, by a first computing device associated with a wireless network of a premises and from a second computing device, a request to access the wireless network;
sending, via a power line network associated with the premises, an access code;
sending, to the second computing device, a first message requesting that the second computing device provide the access code;
sending, after determining that the access code has not been received within a threshold amount of time after the first message was sent, a second message requesting the second computing device to connect to the power line network; and
sending, after receiving the access code from the second computing device, information for accessing the wireless network.

17. The method of claim 16, wherein the request to access the wireless network comprises an identifier of the second computing device, the method further comprising:
determining that the identifier of the second computing device is valid.

18. The method of claim 16, wherein the request to access the wireless network comprises an identifier of the second computing device, the method further comprising:
determining, based on the identifier, information indicating expected behavior of the second computing device.

19. The method of claim 18, further comprising:
monitoring behavior of the second computing device; and
determining, based on the monitored behavior of the second computing device and on the information indicating the expected behavior of the second computing device, whether network access for the second computing device should be blocked or throttled.

20. The method of claim 16, further comprising:
sending, after determining that an incorrect access code has been received, a third message requesting the second computing device to connect to the power line network.
